(19) United States
(12) Patent Application Publication
(10) Pub. No.: US 2019/0062018 A1
(43) Pub. Date: Feb. 28, 2019

(54) Pill Cushion

(71) Applicant: Sheila Tanita McClellan, Philadelphia, PA (US)

(72) Inventor: Sheila Tanita McClellan, Philadelphia, PA (US)

(21) Appl. No.: 15/817,111

(22) Filed: Nov. 17, 2017

Related U.S. Application Data
(60) Provisional application No. 62/550,737, filed on Aug. 28, 2017.

(51) Int. Cl. B65D 71/70; B65D 81/05; A61J 7/00; B65D 85/20

(52) U.S. Cl. CPC B65D 71/70; B65D 81/051; A61J 1/03; B65D 85/20; A61J 7/0069

(57) ABSTRACT

A device for organizing and securing a plurality of pill bottles includes a container with an insert having cutout for receiving pill bottles. Some embodiments have a lid or closure. In some preferred embodiments, the pill bottles are received in the cutouts of the insert in a friction fit so that the pill bottles are held securely in place. In some embodiments the lid may be provided with a key or combination lock to prevent unauthorized access to the medication.

### CROSS-REFERENCE TO RELATED APPLICATIONS

This application claims the benefit of U.S. Provisional Application No. 62/550,737, filed on Aug. 28, 2017, which is incorporated herein by reference in its entirety.

### BACKGROUND OF THE INVENTION

Patients, especially elderly patients, may have to take a variety medications. These medications are usually in pill form and each medication comes in its own cylindrical bottle as supplied by pharmacies. It is not uncommon for patients to have to deal with half a dozen or more different pill bottles, which the patient has to keep track of and keep organized. This can become quite a chore, especially when travelling. Also, it is all too easy for a patient to knock over and spill the pills from an open bottle sitting on a table, night stand, or the like when reaching for the pills. It is also desirable to limit access to the medications to authorized users only.

### SUMMARY OF THE INVENTION

The present invention is directed to a device for organizing and securing a plurality of pill bottles. The disclosed embodiments include a container with an insert having cutouts for receiving pill bottles. Some embodiments have a lid or closure. In some preferred embodiments, the pill bottles are received in the cutouts of the insert in a friction fit so that the pill bottles are held securely in place. In some embodiments the lid may be provided with a key or combination lock to prevent unauthorized access to the medication.

Accordingly, it is an aspect of the present invention to provide a pill bottle holding device comprising:

a container with a top opening;

an insert having a plurality of cutouts, each cutout being configured to receive a pill bottle, the insert fitting securely inside the container.

It is another aspect of the present invention to provide a pill bottle holding device according to any of the other aspects of the present invention disclosed herein, further comprising a lid acting as a closure for the container to selectively close off the top opening of the container.

It is still another aspect of the present invention to provide a pill bottle holding device according to any of the other aspects of the present invention disclosed herein, wherein the lid is hinged to the container and is pivotally movable between a closed and open position. It is yet another aspect of the present invention to provide a pill bottle holding device according to any of the other aspects of the present invention disclosed herein, further comprising a latch for securing the lid in the closed position.

It is yet another aspect of the present invention to provide a pill bottle holding device according to any of the other aspects of the present invention disclosed herein, further comprising a key or combination lock for preventing unauthorized persons from opening the lid.

It is yet another aspect of the present invention to provide a pill bottle holding device according to any of the other aspects of the present invention disclosed herein, wherein each of the plurality of cutouts is X-shaped in plan view.

It is yet another aspect of the present invention to provide a pill bottle holding device according to any of the other aspects of the present invention disclosed herein, wherein each of the plurality of cutouts is X-shaped with a centrally located, superimposed square in plan view.

It is yet another aspect of the present invention to provide a pill bottle holding device according to any of the other aspects of the present invention disclosed herein, wherein each of the plurality of cutouts is circular with a plurality of radial slots extending outward from the circumference of the circle in plan view.

It is yet another aspect of the present invention to provide a pill bottle holding device according to any of the other aspects of the present invention disclosed herein, wherein the insert is made of a foam material.

It is yet another aspect of the present invention to provide a pill bottle holding device according to any of the other aspects of the present invention disclosed herein, wherein the insert is made of a foam rubber material that is both flexible and resilient.

It is yet another aspect of the present invention to provide a pill bottle holding device according to any of the other aspects of the present invention disclosed herein, wherein the insert is made of a foam material selected from polyurethane foam, foamed Neoprene, EVA foam, EVA foam rubber, polyurethane foam rubber, natural latex foam rubber, and styrene-butadiene foam rubber.

It is yet another aspect of the present invention to provide a pill bottle holding device according to any of the other aspects of the present invention disclosed herein, wherein each of the plurality of cutouts can securely hold pill bottles of a variety of sizes.

It is yet another aspect of the present invention to provide a pill bottle holding device according to any of the other aspects of the present invention disclosed herein, wherein two or more of the plurality of cutouts are identical.

It is yet another aspect of the present invention to provide a pill bottle holding device according to any of the other aspects of the present invention disclosed herein, wherein each of the plurality of cutouts are identical.

It is yet another aspect of the present invention to provide a pill bottle holding device according to any of the other aspects of the present invention disclosed herein, wherein the insert is thick enough so that the entire height of a pill bottle can be received inside any one of the plurality of cutouts.

It is yet another aspect of the present invention to provide a pill bottle holding device according to any of the other aspects of the present invention disclosed herein, wherein the insert is thick enough so that the entire height of a pill bottle of the largest standard size can be received inside any one of the plurality of cutouts.

These and other aspects and advantages of the present invention will be further elucidated by the following Detailed Description, drawing figures, and Claims.

### BRIEF DESCRIPTION OF THE DRAWING FIGURES

FIGS. 1-2 show a first embodiment of the pill bottle holding device according to the present invention.

FIGS. 3-5 show a second embodiment of the pill bottle holding device according to the present invention.

FIG. 6 shows an alternative insert for use with the container of the embodiment of FIGS. 3-5.

FIG. 7 shows yet another alternative insert for use with the container of the embodiment of FIGS. 3-5.

FIG. 8 shows an alternative container for use with the embodiment of FIGS. 3-5 that has a different position for the lock.

### DETAILED DESCRIPTION

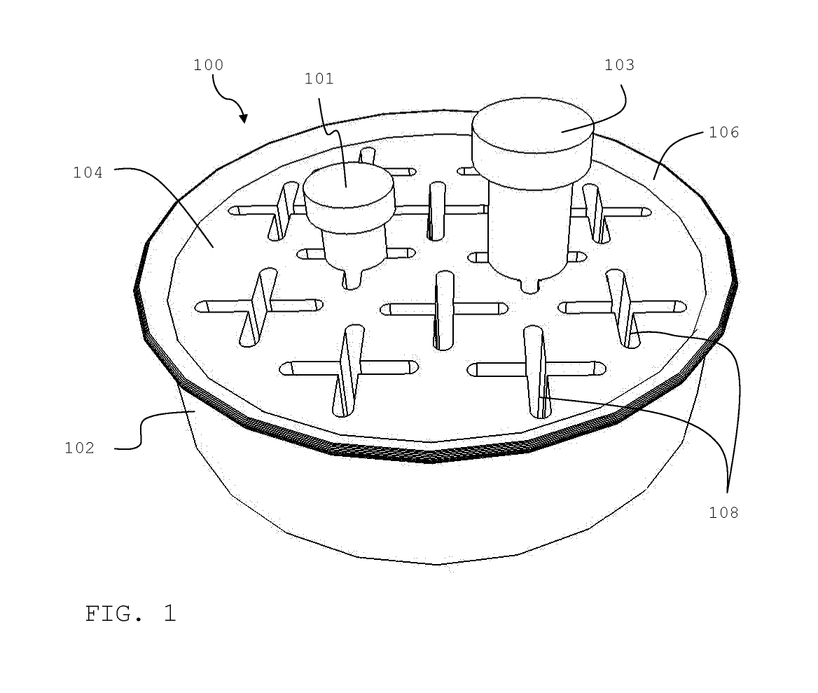

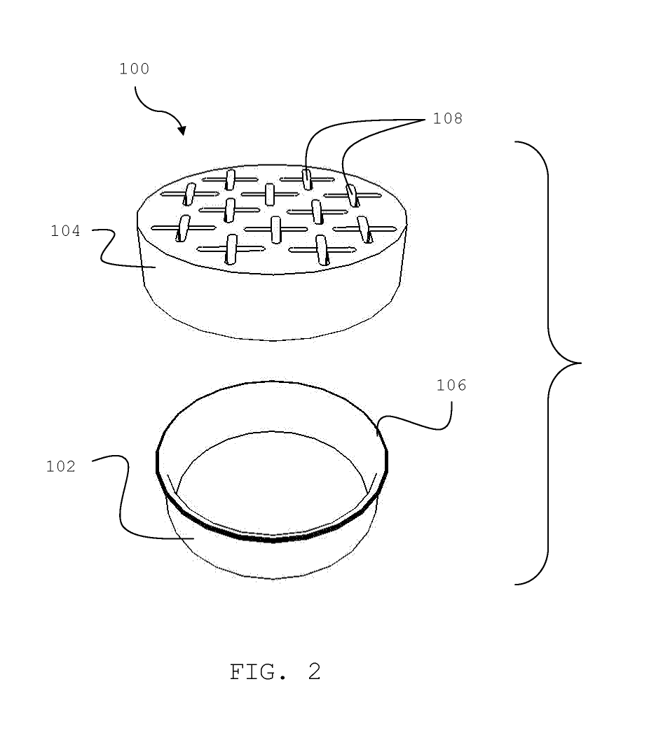

Referring to FIGS. 1-2, an illustrative embodiment of a pill bottle holding device 100 can be seen. The pill bottle holding device 100 includes a container 102 and an insert 104. The container 102 has a top opening 106. The insert 104 has a plurality of cutouts 108. Each cutout 108 is configured to receive a pill bottle 101, 103 of the type normally used by pharmacies to dispense medication in the form of pills to patients. The insert 104 fits securely inside the container 102.

In the embodiment 100 of the pill bottle holding device, each of the plurality of cutouts 108 is X-shaped in plan view. Each of the plurality of cutouts 108 can securely hold pill bottles of a variety or range of sizes. For example, one cutout 108 may hold small and medium pill bottles, while a larger cutout 108 may accommodate small, medium, large, and extra-large pill bottles. In the illustrated embodiment of FIGS. 1-2, all of the plurality of cutouts 108 are identical.

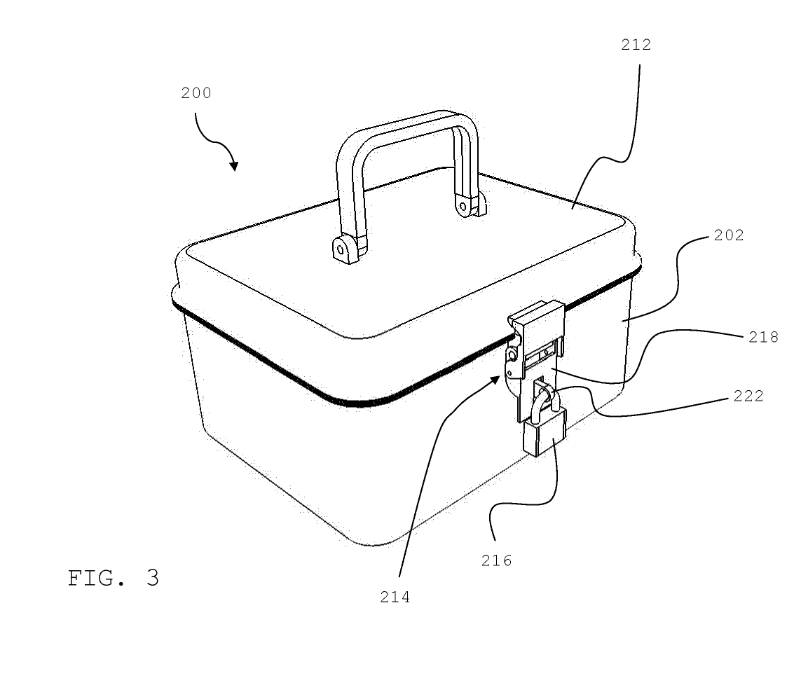

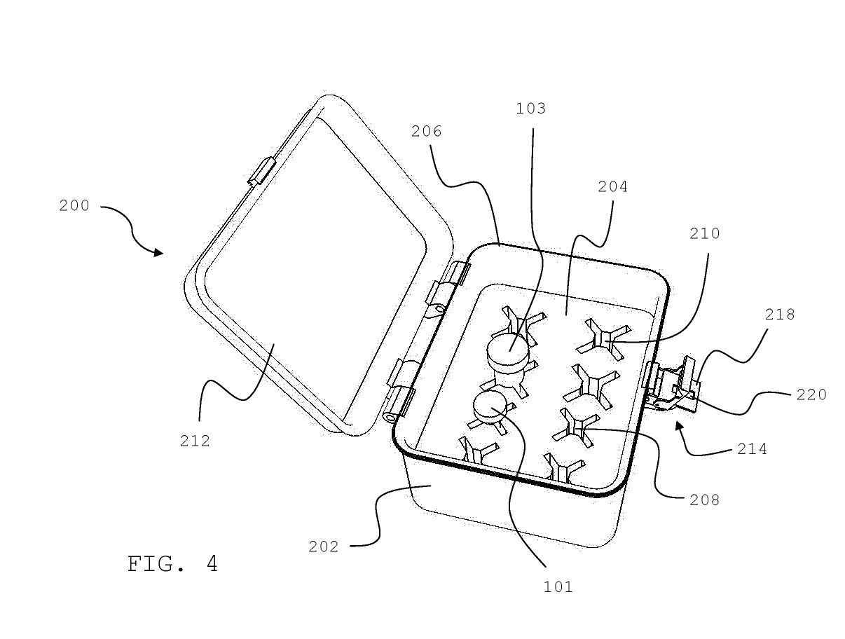

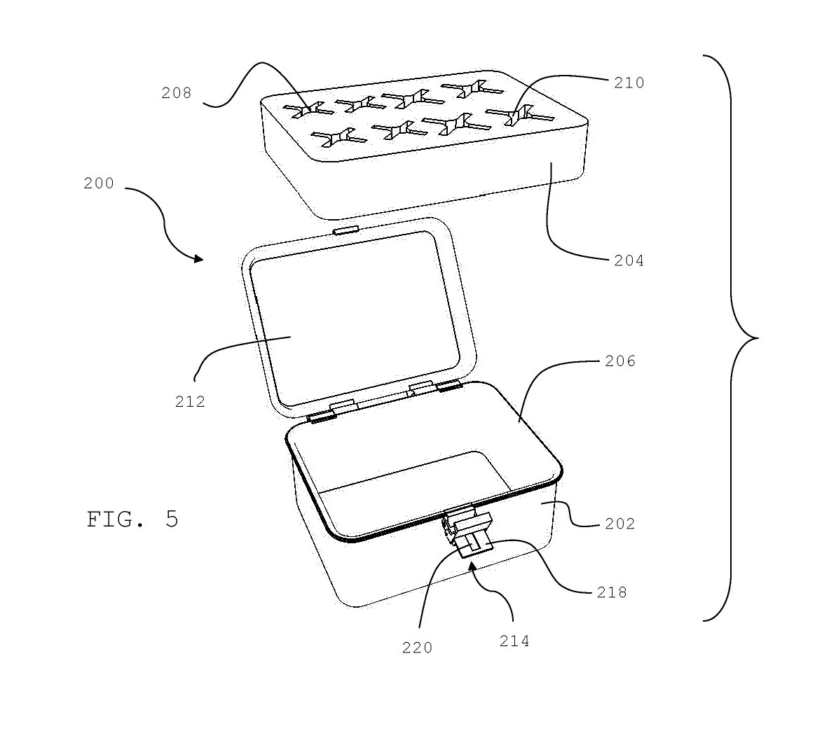

Referring to FIGS. 3-5, a second illustrative embodiment of a pill bottle holding device 200 can be seen. The pill bottle holding device 200 includes a container 202 and an insert 204. The container 202 has a top opening 206. The insert 204 has a plurality of cutouts 208 and 210. Each cutout 208, 210 is configured to receive a pill bottle 101 of the type normally used by pharmacies to dispense medication in the form of pills to patients. The insert 204 fits securely inside the container 202.

In the embodiment 200 of the pill bottle holding device, each of the plurality of cutouts 208, 210 is X-shaped with a centrally located, superimposed square in plan view. Each of the plurality of cutouts 208, 210 can securely hold pill bottles of a variety or range of sizes. For example, one cutout 208 may hold small and medium pill bottles, while the larger cutouts 210 may accommodate small, medium, large, and extra-large pill bottles. In the illustrated embodiment of FIGS. 3-5, two or more of the plurality of cutouts 208, 210 are identical.

The embodiment 200 further includes a lid 212 that acts as a closure for the container 202 to selectively close off the top opening 206 of the container 202. The lid 212 is hinged to the container 202 and is pivotally movable between a closed position and an open position. The pill bottle holding device 200 further includes a latch 214 for securing the lid 212 in the closed position.

The embodiment 200 further includes a key or combination lock 216 for preventing unauthorized persons from opening the lid 212. In the illustrated embodiment 200, the latch 214 is an over-center draw latch. The lever 218 of the draw latch has a slot 220 so that the lever 218 can function as a hasp. A loop 222 is fixed to the container 202 and the loop 222 is positioned through the slot 220 when the lever is in the closed or locked position such that the shackle of the key-locked or combination-locked padlock 216 can be placed through the loop 222 to lock the lid 212 in the closed position relative to the container 202.

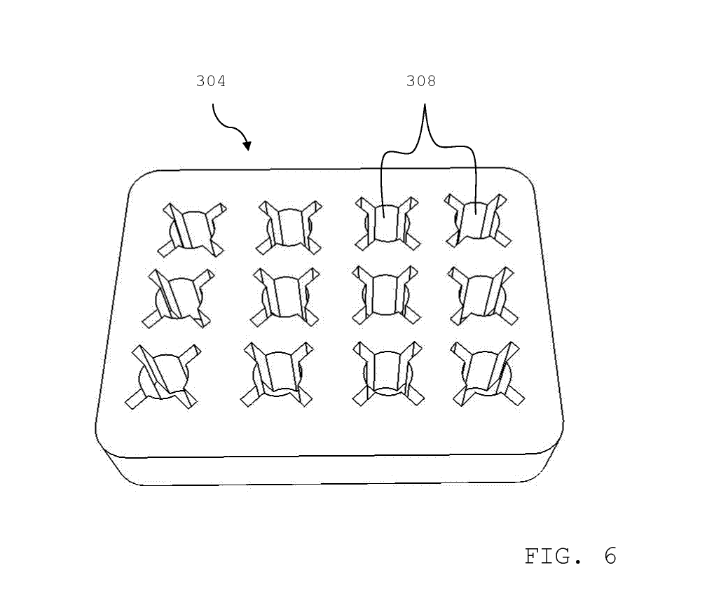

Referring to FIG. 6, an alternative insert 304 for use with the container 202 can be seen. The insert 304 has a plurality of cutouts 308, and each of the plurality of cutouts 308 is circular with a plurality of radial slots extending outward from the circumference of the circular portion of the cutout 308 in plan view. Each of the plurality of cutouts 308 can securely hold pill bottles of a variety of sizes. In the example insert 304, all of the plurality of cutouts 308 are identical.

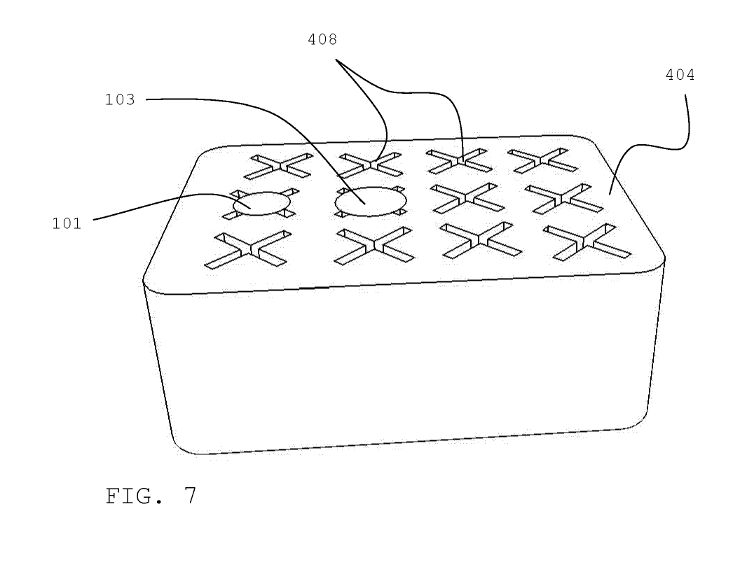

Referring to FIG. 7, an alternative insert 404 for use with the container 202 can be seen. The insert 404 has a plurality of cutouts 408, and each of the plurality of cutouts 408 is X-shaped in plan view. Each of the plurality of cutouts 408 can securely hold pill bottles of a variety or range of sizes. For example, the cutout 408 may hold small, medium, large, and extra-large pill bottles. In the illustrated example insert 404 of FIG. 7, all of the plurality of cutouts 408 are identical.

The insert 404 is thick enough so that the entire height of a pill bottle can be received inside any one of the plurality of cutouts 408. The example insert 404 may even be thick enough so that the entire height of a pill bottle of the largest standard size can be received inside any one of the plurality of cutouts 408.

The inserts 104, 204,304, and 404 are made of a foam material. Preferably, the inserts 104, 204,304, and 404 are made of a foam rubber material that is both flexible and resilient. Examples of suitable material for the inserts 104, 204,304, and 404 include, without limitation, polyurethane foam, foamed Neoprene, EVA foam, EVA foam rubber, polyurethane foam rubber, natural latex foam rubber, and styrene-butadiene foam rubber. Any desired number of cutouts may be provided in the insert depending on the size of the pill bottle holding device, which may be provided in a variety of sizes, such as small, medium, or large, to suit the needs of different individuals. The number of cutouts in an insert may vary from two or three to fifteen or even higher. Preferably, at least four cutouts are provided in the insert. Even more preferably, at least six cutouts are provided in the insert. Yet even more preferably, at least eight cutouts are provided in the insert. Typically, in the range of six to fifteen cutouts would be provided in the insert.

The containers 102, 202 can be made of glass, metal, or a hard, rigid plastic. Plastic is the preferred material for the container 202.

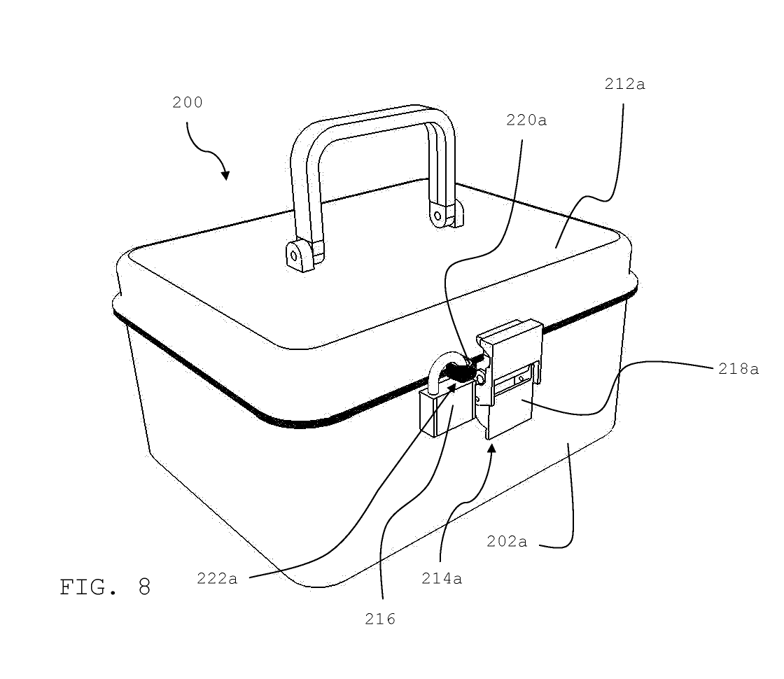

Referring to FIG. 8, an alternative container 202a for use with the embodiment of FIGS. 3-5 can be seen that has a different position for the lock 216. The container 202a has a hole 220a in the lid 212a and a hole 222a near the top opening of the container 202a that are in alignment when the lid 212a is in the closed position. The shackle of the padlock 216 is placed through both holes and the shackle is snapped into the padlock body to lock the lid 212a in the closed position. The lever 218a of the latch 214a does not require a slot.

It should be understood that the present invention is not limited to the specific embodiments described above, but includes any and all variations or modifications within the spirit and scope of the present invention as defined in the appended claims.

1. A pill bottle holding device comprising:
a container with a top opening;
an insert having a plurality of cutouts, each cutout being configured to receive a pill bottle, the insert fitting securely inside said container.

2. The pill bottle holding device of claim 1, further comprising a lid acting as a closure for said container to selectively close off said top opening of said container.

3. The pill bottle holding device of claim 2, wherein said lid is hinged to said container and is pivotally movable between a closed and open position.

4. The pill bottle holding device of claim 3, further comprising a latch for securing said lid in the closed position.

5. The pill bottle holding device of claim 4, further comprising a key or combination lock for preventing unauthorized persons from opening said lid.

6. The pill bottle holding device of claim 1, wherein each of said plurality of cutouts is X-shaped in plan view.

7. The pill bottle holding device of claim 1, wherein each of said plurality of cutouts is X-shaped with a centrally located, superimposed square in plan view.

8. The pill bottle holding device of claim 1, wherein each of said plurality of cutouts is circular with a plurality of radial slots extending outward from the circumference of the circle in plan view.

9. The pill bottle holding device of claim 1, wherein said insert is made of a foam material.

10. The pill bottle holding device of claim 1, wherein said insert is made of a foam rubber material that is both flexible and resilient.

11. The pill bottle holding device of claim 1, wherein said insert is made of a foam material selected from polyurethane foam, foamed Neoprene, EVA foam, EVA foam rubber, polyurethane foam rubber, natural latex foam rubber, and styrene-butadiene foam rubber.

12. The pill bottle holding device of claim 1, wherein each of said plurality of cutouts can securely hold pill bottles of a variety of sizes.

13. The pill bottle holding device of claim 12, wherein two or more of said plurality of cutouts are identical.

14. The pill bottle holding device of claim 12, wherein each of said plurality of cutouts are identical.

15. The pill bottle holding device of claim 12, wherein said insert is thick enough so that the entire height of a pill bottle can be received inside any one of said plurality of cutouts.

16. The pill bottle holding device of claim 12, wherein said insert is thick enough so that the entire height of a pill bottle of the largest standard size can be received inside any one of said plurality of cutouts.
